(19) United States
(12) Patent Application Publication
(10) Pub. No.: US 2006/0132493 A1
(43) Pub. Date: Jun. 22, 2006

(54) Display apparatus

(75) Inventor: Isao Akima, Ogaki-shi (JP)

Correspondence Address: SHERIDAN ROSS PC, 1560 BROADWAY, SUITE 1200, DENVER, CO, 80202, US

(73) Assignee: SANYO ELECTRIC CO., LTD.

(21) Appl. No.: 11/286,174

(22) Filed: Nov. 22, 2005

(30) Foreign Application Priority Data
Nov. 25, 2004 (JP) 2004-340179

(51) Int. Cl. G06F 13/14

(52) U.S. Cl. 345/520

(57) ABSTRACT

A display apparatus includes a video signal processing unit, a display panel, and a bidirectional bus. The video signal processing unit transmits a video signal via the bidirectional bus. The display panel displays an image in accordance with the video signal. The video signal processing unit and the display module are connected to the bidirectional bus. When a tester is connected to the bidirectional bus, the bidirectional bus directly connects the tester to the video signal processing unit and the display module. The tester separately tests the video signal processing unit and the display panel after the display apparatus is assembled.

### CROSS-REFERENCE TO RELATED APPLICATIONS

This application is based upon and claims the benefit of priority from prior Japanese Patent Application No. 2004-340179, filed on Nov. 25, 2004, the entire contents of which are incorporated herein by reference.

### BACKGROUND OF THE INVENTION

The present invention relates to a display apparatus, and more particularly, to a display apparatus including a display panel such as a liquid crystal display (LCD) panel.

Known display apparatuses include display panels such as LCD panels. In such a display apparatus, pixels are driven in accordance with video data to show videos. An article entitled “Detailed Explanation on Color LCD System” written by Hiroyuki Nitta and Yasuyuki Kudo, on pp. 255-268 of Transistor Gijutsu September 2000, published by CQ Publishing Co., Ltd. on Sep. 1, 2000, describes changing the arrangement of liquid crystal molecules and controlling the light transmission amount of an LCD panel to show an image. The article describes another display system uses light emitting elements such as LEDs (light emitting diodes) and controls the light emission amount of the LEDs to show an image.

A conventional display includes a display region formed by a matrix of pixels. It is extremely difficult to uniformly set the light transmission amount or the light emission amount throughout the entire display region. When the light transmission amount or the light emission amount is imbalanced, this may cause defects and form defective points, blots, and non-uniform areas. To find such defects before a display apparatus is shipped out of a manufacturing factory, the display apparatus undergoes inspection, which is conducted visually by human eyes or by machines.

A typical conventional display includes a display module and a video signal processing unit. The display module has a display panel and a drive circuit. The video signal processing unit drives the display module in accordance with video data. When inspecting the display apparatus, a tester is used to show an image on the display panel with the video signal processing unit. An inspector who conducts the test checks whether the display apparatus has a defect based on the displayed image. However, even if a defect is found, it cannot be determined whether the defect is in the video signal processing unit or the display module.

The inspection result of the display apparatus is used only to improve the manufacturing processes of the display apparatus. Even if a defect is found in the conventional display during an inspection, the defect is not corrected so as to improve the display quality of that display. Thus, such a defective display having poor display quality is discarded. This lowers the yield in producing conventional displays.

### SUMMARY OF THE INVENTION

It is an object of the present invention to provide a display apparatus enabling the signal processing unit and display module to be separately inspected after the display apparatus is assembled. It is another object of the present invention to provide a display apparatus enabling correction of the display quality of the display module.

One aspect of the present invention is a display apparatus including a bidirectional bus. A video signal processing unit, connected to the bidirectional bus, transmits a video signal via the bidirectional bus. A display module, connected to the bidirectional bus, displays an image in accordance with the video signal.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram of a display apparatus according to a preferred embodiment of the present invention;

FIG. 2 is a block diagram of a device test circuit and a bidirectional bus control circuit;

FIG. 3 is a circuit diagram of a data output circuit and a data input circuit;

FIG. 4 is an explanatory diagram of a video display period and a blanking period; and

FIG. 5 is a circuit diagram of an input control circuit incorporated in a display module.

### DETAILED DESCRIPTION OF THE PREFERRED EMBODIMENTS

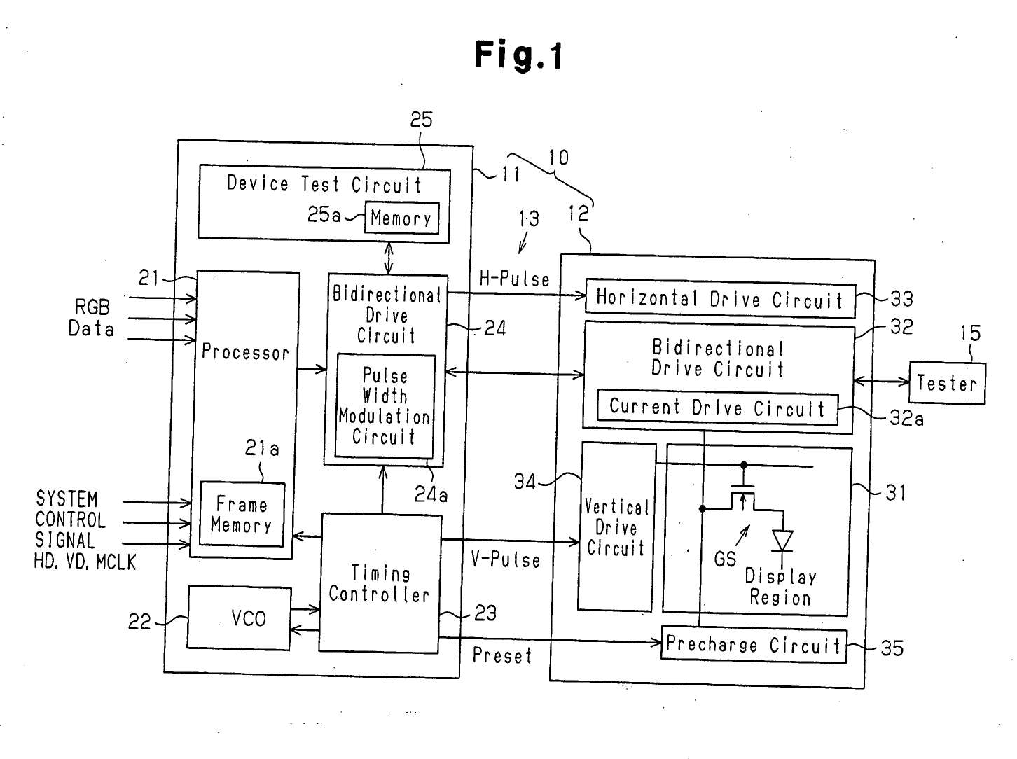

A display apparatus 10 according to a preferred embodiment of the present invention will now be described with reference to FIGS. 1 to 5. The display apparatus 10 includes a video signal processing unit 11 and a display module (display panel) 12. The video signal processing unit 11 and the display module 12 are connected to a bidirectional bus 13. The video signal processing unit 11 generates a video signal in accordance with video data (e.g., RGB data) that is provided from an external device. The video signal processing unit 11 transmits the video signal and various control signals including a timing signal to the display module 12 via the bidirectional bus 13. The display module 12 displays an image in accordance with a pulse width modulation signal and the various control signals received via the bidirectional bus 13.

A tester 15, which is used to test the video data display apparatus 10, is connectable to the bidirectional bus 13. As one example, the tester 15 may be directly connected to the display module 12 after the video data display apparatus 10 is assembled. In this case, the display module 12 may be solely tested with the tester 15 after the video data display apparatus 10 is assembled.

Examples of the tester 15 include a display tester, an electrical signal tester, and an imaging device such as a charge-coupled device (CCD). When the display tester is connected to the bidirectional bus 13, the display tester transmits predetermined test data (signal for displaying a test image) to the display module 12 via the bidirectional bus 13. The display module 12 displays an image (test image) in accordance with the test data. An inspector who is conducting the test visually checks the image to inspect the video data display apparatus 10.

When the electrical signal tester is connected to the bidirectional bus 13, the electrical signal tester shows the waveform or analyzes the timing of a signal transmitted via the bidirectional bus 13. The inspector inspects the video data display apparatus 10 based on the shown waveform or analysis result.

The video signal processing unit 11 is capable of storing correction data. The video signal processing unit 11 is further capable of synthesizing video data and correction data that are provided from an external device. The correction data is provided via the bidirectional bus 13. For example, the display tester and the imaging device may be connected to the bidirectional bus 13. In this case, the imaging device images an image (test image) that is displayed on the display module 12 in accordance with test data provided from the display tester to generate recognition data that is in accordance with the test data. The display tester compares the recognition data provided from the imaging device with the test data to generate correction data. The correction data is transmitted to the video signal processing unit 11 via the bidirectional bus 13. The video signal processing unit 11 then stores the correction data. The video signal processing unit 11 corrects the externally provided video data based on the correction data that has been generated in according with the characteristic of the display module 12. For example, when the display module 12 has a defect and has a non-uniform area, the tester 15 generates correction data in accordance with the defect. The correction data and the video data are synthesized so as to correct the defect of the display module 12.

The video signal processing unit 11 is provided with a testing function. By using the testing function, the video signal processing unit 11 controls the tester 15 that is connected to the bidirectional bus 13. With the testing function, the video signal processing unit 11 generates correction data based on measurement data received from the tester 15 and stores the generated correction data. The measurement data generated by the tester 15 is for at least either one of brightness and RGB color difference. Next, the video signal processing unit 11 transmits to the display module 12 a pulse width modulation signal that is obtained by synthesizing the generated correction data and video data. The video signal processing unit 11 repeats the above process for a number of times. The video signal processing unit 11 executes, for example, time-shared control, to alternately repeat the display of a test image, the measurement of the test image, and the generation of correction data. As a result, highly accurate correction data is obtained. In detail, the correction of the characteristics of the part related to images is ensured. This ensures that every correctable defect in the display apparatus 10 is eliminated.

The display and measurement of an image are performed during a video display period in which a video is shown and a non-video display period during which no video is shown. As shown in FIG. 4, the display module 12 is controlled to display the received signal during the video display period and not to display the signal during a blanking period (non-video display period). An image is displayed during the video display period (first period), and the measurement and generation of correction data are performed during the blanking period (second period). More specifically, the video signal processing unit 11 transmits a pulse width modulation signal, which is based on video data, to the display module 12 during the first period so that the display module 12 displays an image in accordance with the pulse width modulation signal. The tester 15 measures the image displayed by the display module 12. The video signal processing unit 11 receives measurement data, which is the test result, from the tester 15 during the second period and stores the correction data generated by comparing the measurement data and the video data. Then, the video signal processing unit 11 transmits the pulse width modulation signal, which is generated by synthesizing the correction data and the video data, to the display module 12. Such time-shared control enables the video displayed on the display module 12 to be the same as a video that would be displayed when the test (measurement and generation of correction data) is not conducted. In this way, the time-shared control enables correction data to be generated without the inspector having any awkward visual perception.

The components of the video data display apparatus 10 will now be described.

The video signal processing unit 11 includes a processor unit 21, a voltage controlled oscillator (VOC) 22, a timing controller 23, a bidirectional bus drive circuit 24 functioning as a bus control circuit, and a device test circuit 25 functioning as a test processor and a test controller.

The processor unit 21 performs predetermined signal processing on the RGB video data provided from an external device. The processor unit 21 includes a frame memory 21a for storing video data that has undergone the signal processing. The processor unit 21 converts the externally provided RGB video data into video data that is formed by bits corresponding in number to the gradation levels. The processor unit 21 stores, in units of frames, the converted video data in the frame memory 21a.

The VOC 22 generates a clock signal for operating the video signal processing unit 11 and the display module 12. Based on an output signal of the VOC 22, the timing controller 23 generates various timing signals, which are used by the video signal processing unit 11, and various timing signals, which are used by the display module 12.

The bidirectional bus drive circuit 24 controls data output and data input of the bidirectional bus 13. The bidirectional bus drive circuit 24 includes a pulse width modulation circuit 24a. The pulse width modulation circuit 24a is operated in accordance with a timing signal, and generates an RGB pulse width modulation signal based on video data read from the frame memory 21a. The pulse width modulation signal has a pulse width that is in accordance with the graduation level value.

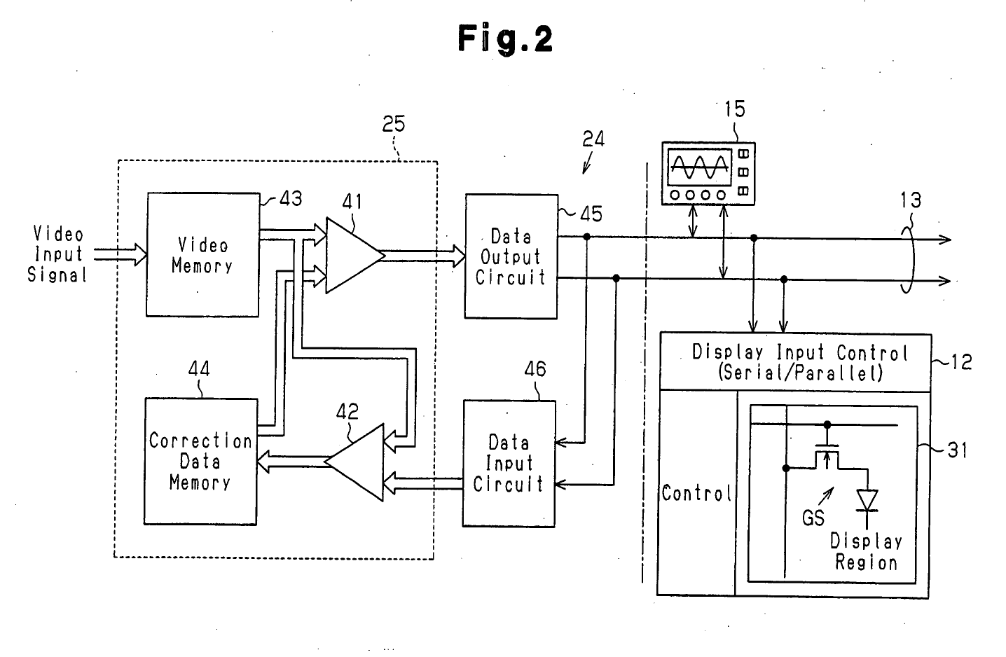

The device test circuit 25 provides the testing function, which is described above. The device test circuit 25 includes a memory 25a, which functions as a storage for storing the video data that is tested (test video data) and correction data. The device test circuit 25 includes a first calculation circuit 41 and a second calculation circuit 42, as shown in FIG. 2. The memory 25a shown in FIG. 1 is formed by a video memory 43 and a correction data memory 44, as shown in FIG. 2. Predetermined test video data (e.g., all white image data) is stored in the video memory 43 during testing. During normal operation, externally input video data (video input signal) is input into the video memory 43. The first calculation circuit 41 synthesizes (e.g., adds) video data read from the video memory 43 and correction data read from the correction data memory 44 and then outputs the operational result. The second calculation circuit 42 generates difference value data, which indicates the difference between the input measurement data and the video data read from the video memory 43. The difference value data is stored in the correction data memory 44 as the correction data.

As shown in FIG. 2, the bidirectional bus drive circuit 24 includes a data output circuit 45 and a data input circuit 46. The data output circuit 45 is a parallel-serial converter. The data output circuit 45 converts a parallel signal having a plurality of bits output from the device test circuit 25 into a serial signal to provide the serial signal to the bidirectional bus 13. The data input circuit 46 is a serial-parallel converter. The data input circuit 46 converts the serial signal from the bidirectional bus 13 into a parallel signal to provide the parallel signal to the device test circuit 25.

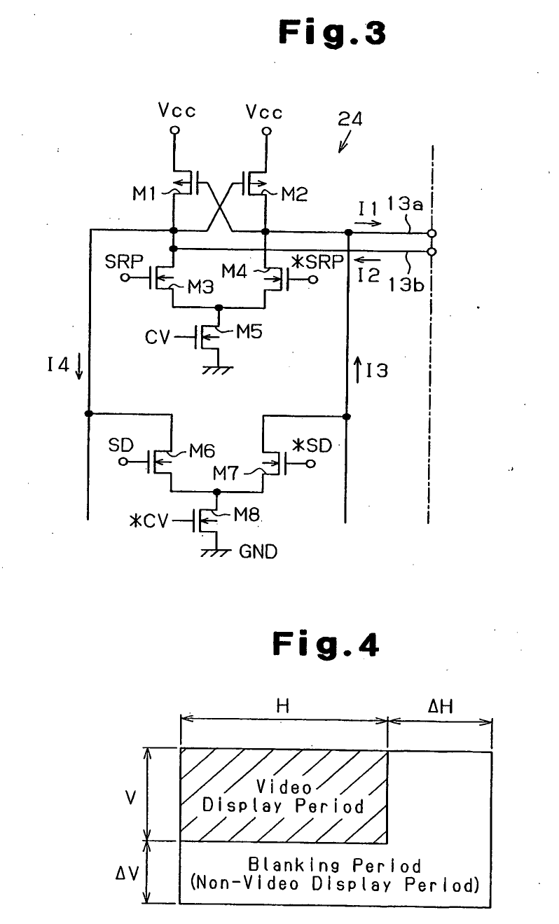

As shown in FIG. 3, the bidirectional bus drive circuit 24 generates first and second drive currents I1 and I2 for transmitting video data in accordance with pulse width modulation signals SRP and *SRP that are complementary to each other. The bidirectional bus drive circuit 24 includes transistors M1 to M8. The pair of constant voltage pulse width modulation signals SRP and *SRP are signals generated in accordance with red (R) information included in the video data. In addition to the R information, the video data further includes green (G) information and blue (B) information. Although not shown, the bidirectional bus drive circuit 24 further includes circuits (transistors) corresponding to constant voltage pulse modulation signals for the G information and B information.

The pair of P-channel MOS transistors M1 and M2 have sources supplied with power supply voltage Vcc. The gates and drains of the transistors M1 and M2 are cross-connected. The pair of N-channel MOS transistors M3 and M4 form a differential transistor pair. The N-channel MOS transistor M5 is connected between a low-potential power supply (ground GND in the preferred embodiment) and a node at which the sources of the transistors M3 and M4 are connected to each other. The N-channel MOS transistor M3 has a gate provided with the constant voltage pulse width modulation signal SRP. The N-channel MOS transistor M4 has a gate provided with the constant voltage inverse pulse width modulation signal *SRP. The N-channel MOS transistor M5 has a gate provided with a video period signal CV. The video period signal CV has a high (H) level during a video display period and a low (L) level during a non-video display period.

The bidirectional bus 13 includes a pair of transmission paths 13a and 13b. The second transmission path 13b is connected to the drain of the N-channel MOS transistor M3. The first transmission path 13a is connected to the drain of the N-channel MOS transistor M4. The first and second transmission paths 13a and 13b are arranged adjacent to each other and are laid out from the video signal processing unit 11 toward the display module 12. The first and second transmission paths 13a and 13b are respectively supplied with the first and second drive currents I1 and I2 in accordance with the on and off states of the N-channel MOS transistors M3 and M4. The first and second drive currents I1 and I2 have identical values and flow in opposite directions. More specifically, the transistors M1 to M5 form a data output circuit (first output circuit) that generates the drive currents I1 and I2 in accordance with the constant voltage pulse width modulation signals SRP and *SRP during a video display period.

The drain of the N-channel MOS transistor M6 is connected to the second transmission path 13b. The drain of the N-channel MOS transistor M7 is connected to the first transmission path 13a. The pair of N-channel MOS transistors M6 and M7 form a differential transistor pair. The N-channel MOS transistor M8 is connected between a node at which the sources of the transistors M6 and M7 are connected to each other and a low-potential power supply (ground GND in the preferred embodiment). A device signal SD is provided to the gate of the N-channel MOS transistor M6. A device signal *SD is provided to the gate of the N-channel MOS transistor M7. An inversion video period signal *CV is provided to the gate of the N-channel MOS transistor M8. The inversion video period signal *CV is obtained by inverting the video period signal CV. The inversion video period signal *CV has an L level during a video display period and an H level during a non-video display period.

The first and second transmission paths 13a and 13b are respectively supplied with third and fourth drive currents I3 and I4 in accordance with the on and off states of the N-channel MOS transistors M6 and M7. The third and fourth drive currents I3 and I4 have identical values and flow in opposite directions. More specifically, the transistors M1, M2, M6, M7, and M8 form a data output circuit (second output circuit) for current-voltage conversion that generates the drive currents I3 and I4 in accordance with the device signals SD and *SD during a non-video display period.

As shown in FIG. 1, the display module 12 includes a display region 31, a bidirectional bus drive circuit 32, a horizontal drive circuit 33, a vertical drive circuit 34, and a precharge circuit 35. The display region 31 is formed by a matrix of cells GS. FIG. 4 shows a single cell GS. The horizontal drive circuit 33 and the vertical drive circuit 34 sequentially select the cells GS included in the display region 31 in response to a H-pulse (horizontal scan pulse) and a V-pulse (vertical scan pulse) that are provided from the video signal processing unit 11.

The bidirectional bus drive circuit 32 controls data output and input of the bidirectional bus 13. The bidirectional bus drive circuit 32 includes a current drive circuit 32a. The current drive circuit 32a supplies drive current, which is received via the bidirectional bus 13, to the selected cell GS. The precharge circuit 35 precharges a drain line to which the cell GS is connected in response to a signal Preset provided from the video signal processing unit 11.

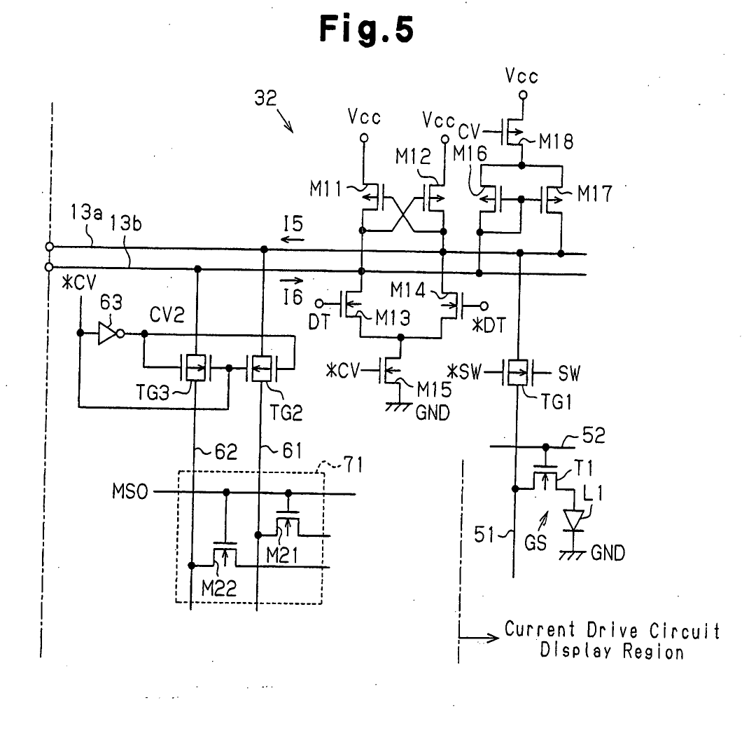

As shown in FIG. 5, the bidirectional bus drive circuit 32 includes a pair of P-channel MOS transistors M11 and M12. Each of the transistors M11 and M12 has a source supplied with power supply voltage Vcc. The transistors M11 and M12 have gates and drains that are cross-connected. The drain of the transistor M11 is connected to the second transmission path 13b. The drain of the transistor M12 is connected to the first transmission path 13a. A pair of N-channel MOS transistors M13 and M14 form a differential transistor pair. The drain of the transistor M13 is connected to the second transmission path 13b. The drain of the transistor M14 is connected to the first transmission path 13a. An N-channel MOS transistor M15 is connected between a low-potential power supply (ground GND in the preferred embodiment) and a node at which the sources of the transistors M13 and M14 are connected to each other. A data signal DT is provided to the gate of the transistor M13. An inversion data signal *DT is provided to the gate of the transistor M14. An inversion video period signal *CV is provided to the gate of the N-channel MOS transistor M15.

The first and second transmission paths 13a and 13b are respectively provided with fifth and sixth drive currents I5 and I6 in accordance with the on and off states of the N-channel MOS transistors M13 and M14. The fifth and sixth drive currents I5 and I6 have identical values and flow in opposite directions. More specifically, the transistors Mll to M15 form a data output circuit that generates the drive currents I5 and I6 in accordance with the data signals DT and *DT during a non-video display period. In other words, the bidirectional bus drive circuit 32 functions as a data output circuit that generates the fifth and sixth drive currents I5 and I6 for transmitting data from the display module 12 to the video signal processing unit 11 in accordance with the complementary data signals DT and *DT.

The current drive circuit 32a includes P-channel MOS transistors M16, M17, and M18. The transistors M16 and M17 are connected to form a current mirror. The drain of the transistor M16 is connected to the second transmission path 13b. The drain of the transistor M17 is connected to the first transmission path 13a. The drain of the P-channel MOS transistor M18 is connected to a node at which the sources of the transistors M16 and M17 are connected to each other. The transistor M18 has a source supplied with power supply voltage Vcc and a gate provided with a video period signal CV. The transistors M16 to M18 cause the drive currents I1 and I2 flowing through the first and second transmission paths 13a and 13b to have identical values during a video display period.

In the current drive circuit 32a, a CMOS (complementary metal oxide semiconductor) transfer gate TG1 is connected to the first transmission path 13a. The CMOS transfer gate TG1 performs switching in accordance with switching signals SW and *SW (*SW is obtained by inverting SW) and supplies the first drive current I1 to a drain line 51. The switching signals SW and *SW are horizontal scan signals and provided from the horizontal drive circuit 33 shown in FIG. 1.

A pixel GS included in the display region 31 of the display panel is arranged in or near the intersection of the drain line 51 and a gate line 52. The pixel GS includes a pixel selection transistor T1 and a current drive light emitting element L1 (e.g., a current drive liquid crystal element, such as an LED element, an organic EL element, an inorganic EL element, or a TFD element). The pixel selection transistor T1 is a thin film transistor (TFT). The gate line 52 is connected to the gate of the pixel selection transistor T1. The vertical drive circuit 34 shown in FIG. 1 provides a vertical scan signal to the gate line 52. The pixel selection transistor T1 performs switching in accordance with the vertical scan signal and supplies the first drive current I1 from the drain line 51 to the current drive type light emitting element L1. Although not shown in the drawings, a transfer gate, a drain line, a pixel GS, and a gate line are connected to the second transmission path 13b in the same manner.

In the bidirectional bus drive circuit 32, a third transmission path 61 is connected to the first transmission path 13a via a CMOS transfer gate TG2. A fourth transmission path 62 is connected to the second transmission path 13b via a CMOS transfer gate TG3. An inversion video period signal *CV and a signal CV2, which is obtained by inverting the inversion video period signal *CV with the inverter circuit 63, are provided to the transfer gates TG2 and TG3. The signals *CV and CV2 cause both of the transfer gates TG2 and TG3 to be turned off during a video display period and turned on during a non-video display period. As a result, the third and fourth transmission paths 61 and 62 are electrically disconnected from the first and second transmission paths 13a and 13b during a video display period and are electrically connected to the first and second transmission paths 13a and 13b during a non-video display period.

A plurality of selection circuits 71 (only one is shown in FIG. 5) are connected to the third and fourth transmission paths 61 and 62. Each selection circuit 71 is formed by N-channel MOS transistors M21 and M22. The transistors M21 and M22 have first terminals respectively connected to the third and fourth transmission paths 61 and 62, second terminals connected to external devices (the tester 15, other display modules, etc.), and gates provided with a selection signal MSO. One of the selection circuits 71 is selected based on the selection signal. The device connected to the selected selection circuit 71 (e.g., the tester 15) is connected to the third and fourth transmission paths 61 and 62. The third and fourth transmission paths 61 and 62 are connected to the first and second transmission paths 13a and 13b during a non-video display period. Thus, an external device, such as the tester 15, is connected to the video signal processing unit 11 via the first and second transmission paths 13a and 13b and the third and fourth transmission paths 61 and 62 during a non-video display period. This enables the video signal processing unit 11 to receive various types of data (test data, recognition data, correction data, etc.) from the tester 15.

The preferred embodiment has the advantages described below.

(1) The display apparatus 10 includes the video signal processing unit 11, which transmits a video signal via the bidirectional bus, and the display module 12, which displays an image in accordance with the video signal. The video signal processing unit 11 and the display module 12 are connected to each other by the bidirectional bus 13. When the tester 15 is connected to the bidirectional bus 13, the tester 15 is connected directly to the video signal processing unit 11 and the display module 12. The bidirectional bus 13 enables data transmission between the tester 15 and the display module 12 and between the tester 15 and the video signal processing unit 11. This enables the tester 15 to separately test the video signal processing unit 11 and the display module 12.

(2) The video signal processing unit 11 includes the device test circuit 25. The device test circuit 25 includes the memory 25a for storing correction data. The device test circuit 25 outputs data obtained by synthesizing video data and correction data. This enables the correction of video data with the correction data generated in accordance with the state of the display module 12. Thus, defects of the display apparatus 10 are eliminated or become less noticeable. In other words, the display apparatus 10 is corrected so as to improve its display quality. This enables the display apparatus 10 of which defects have been corrected to pass final inspections before being shipped out of the manufacturing factory.

(3) The display apparatus 10 includes the device test circuit 25, which controls the tester 15 that is connected to the bidirectional bus 13. This enables the video signal processing unit 11 and the display module 12 to be tested after the display apparatus 10 is shipped out of the manufacturing factory.

(4) The device test circuit 25 generates difference value data, which indicates the difference between video data transmitted to the display module 12 via the bidirectional bus 13 and measurement data received from the tester 15 via the bidirectional bus 13. The difference value data is stored in the memory 25a as the correction data. Thus, the tester 15 is only required to output measurement data that indicates the state of the display module 12. This simplifies the structure of the tester 15, which tests and corrects the display apparatus 10.

(5) The tester 15 is connected to a second bus arranged in the display module 12. The second bus can be electrically or physically connected to and disconnected from the bidirectional bus 13. The second bus is connected to the bidirectional bus 13 when the tester 15 needs to be connected to the display apparatus 10. The second bus is disconnected from the bidirectional bus 13 when the tester 15 does not need to be connected to the display apparatus 10. This prevents the display apparatus 10 from being affected by devices connected to the bidirectional bus 13.

(6) The selection circuits 71 are arranged along the second bus (third and fourth transmission paths 61 and 62). External devices including the tester 15 are connected to the second bus via one selection circuit 71. This ensures that the display apparatus 10, to which the external devices are connected, transmits data to a selected one of the external devices.

(7) The bidirectional bus drive circuit 24 transmits video data, which is used by the display module 12 to display an image, to the bidirectional bus 13 during a first period. Further, the bidirectional bus drive circuit 24 transmits a control signal or measurement data to the bidirectional bus 13 during a second period. In this way, the video data and the control signal or measurement data are transmitted during different periods. The control signal or measurement data is transmitted during a period in which the display module 12 does not display an image that is in accordance with the video data. This enables the transmission of the control signal or measurement data in a manner independent from the image that is displayed on the display module in accordance with the video data.

(8) The bidirectional bus 13 includes at least the single pair of transmission paths 13a and 13b. The bidirectional bus drive circuit 24 generates two drive currents that have identical values and flow in opposite directions in accordance with the transmission data and supplies the two drive currents to the pair of transmission paths 13a and 13b, respectively. The data transmission is enabled by the bidirectional currents that are in accordance with video data and flow through the pair of transmission paths 13a and 13b. Thus, the data transmission does not cause problems such as generation of electromagnetic interference (EMI) noise and a decrease in the signal-to-noise (S/N) ratio of signals. This structure further reduces transmission delays resulting from the transmission capacity and also reduces signal skew. Thus, high-frequency video data signals may be transmitted.

(9) The bidirectional bus drive circuit 24 includes the first output circuit (M1 to M5) and the second output circuit (M1, M2, M6, M7, and M8). In the first period, the first output circuit generates two drive currents that have identical values and flow in opposite directions in accordance with video data. Further, the first output circuit supplies the two opposite-direction drive currents to the two transmission paths, respectively. In the second period, the second output circuit generates two drive currents that have identical values and flow in opposite directions in accordance with a control signal or measurement data. Further, the second output circuit supplies the two drive currents to the two transmission paths, respectively. The control signal or measurement data is transmitted during a period in which an image that is in accordance with the video data is not displayed on the display module. This enables the control signal or measurement data to be transmitted independently from the display of an image that is in accordance with the video data.

(10) The display module 12 includes the bidirectional bus drive circuit 32 that generates two drive currents that have identical values and flow in opposite directions in accordance with the transmission data. Further, the bidirectional bus drive circuit 32 supplies the opposite-direction drive currents to the two transmission paths, respectively. This enables the display module 12 to transmit data to the video signal processing unit 11.

It should be apparent to those skilled in the art that the present invention may be embodied in many other specific forms without departing from the spirit or scope of the invention. Particularly, it should be understood that the present invention may be embodied in the following forms.

The devices connected to the bidirectional bus 13 should not be limited to the tester 15 and the display module. A multimedia device may be connected to the bidirectional bus 13, and signals (data) realizing the function of the multimedia device may be transmitted by bidirectional currents.

An input device, such as a touch panel, may be arranged in the display module 12. In this case, data input from the input device may be transmitted to the video signal processing unit 11 via the bidirectional bus 13. The bidirectional bus 13 eliminates the need for a new interface for transmitting data of another device, such as an input device. In this way, a new function can be easily added to the display apparatus 10 by, for example, adding an input device to the display apparatus 10.

The present examples and embodiments are to be considered as illustrative and not restrictive, and the invention is not to be limited to the details given herein, but may be modified within the scope and equivalence of the appended claims.

What is claimed is:

1. A display apparatus comprising:
a bidirectional bus;
a video signal processing unit, connected to the bidirectional bus, for transmitting a video signal via the bidirectional bus; and
a display module, connected to the bidirectional bus, for displaying an image in accordance with the video signal.

2. The display apparatus according to claim 1, further comprising:
a storage for storing correction data; and
a test processor for outputting data obtained by synthesizing video data and the correction data.

3. The display apparatus according to claim 1, wherein the bidirectional bus is connected to a tester, the display apparatus further comprising:
a test controller for controlling the tester.

4. The display apparatus according to claim 3, wherein the test controller generates difference value data, indicating the difference between video data transmitted to the display module via the bidirectional bus and measurement data received from the tester via the bidirectional bus, and stores the difference value data in the storage as the correction data.

5. The display apparatus according to claim 3, wherein the display module includes a second bus that is connected to the bidirectional bus in an electrically separable manner, and the tester is connected to the second bus.

6. The display apparatus according to claim 5, further comprising:
a plurality of selection circuits arranged on the second bus, with one of the plurality of selection circuits connecting an external device, including the tester, to the second bus.

7. The display apparatus according to claim 1, further comprising:
a bus control unit for controlling the bidirectional bus, wherein the bus control unit provides the bidirectional bus with video data for displaying an image on the display module during a first period and provides the bidirectional bus with a control signal or measurement data during a second period.

8. The display apparatus according to claim 7, wherein the bidirectional bus includes two transmission paths, and the bus control unit generates drive currents, which have identical values and flow in opposite directions in accordance with transmission data, and supplies the two transmission paths respectively with the drive currents.

9. The display apparatus according to claim 8, wherein the bus control unit includes:
a first output circuit for generating drive currents, which have identical values and flow in opposite directions in accordance with the video data, and supplying the two transmission paths respectively with the drive currents during a first period; and
a second output circuit for generating drive currents, which have identical values and flow in opposite directions in accordance with the control signal or measurement data, and supplying the two transmission paths respectively with the drive currents during a second period.

10. The display apparatus according to claim 9, wherein the display module includes another bus control unit for supplying the two transmission paths respectively with currents, which have identical values and are generated in accordance with the transmission data.
